(19) United States
(12) Patent Application Publication
(10) Pub. No.: US 2017/0032275 A1
(43) Pub. Date: Feb. 2, 2017

(54) ENTITY MATCHING FOR INGESTED PROFILE DATA

(71) Applicant: Linkedin Corporation, Mountain View, CA (US)

(72) Inventors: Nikita Igorevych Lytkin, Sunnyvale, CA (US); Nikolai Avteniev, Brooklyn, NY (US); Eran Leshem, New York, NY (US); Brandon Duncan, San Francisco, CA (US); Kumar Hemachandra Chellapilla, Mountain View, CA (US)

(21) Appl. No.: 14/811,295

(22) Filed: Jul. 28, 2015

(51) Int. Cl. G06N 99/00; G06F 17/30; H04L 29/08

(52) U.S. Cl. CPC G06N 99/005; H04L 67/306; G06F 17/30525

(57) ABSTRACT

Disclosed in some examples are methods, systems, and machine readable mediums that utilize information ingested from publicly available network-based data sources to automatically suggest adding additional attributes to member profiles of a social networking service. Among other uses, this system allows for assisted member profile completion. The system ingests information from one or more publicly available network-based data sources (data sources that are different from the social networking service), creates information records that describe potential member profile attributes using that ingested data, identifies members of the social networking service that are associated with the information records using information in the information records and pre-existing member profile attributes, and then prompts one or more members to add the potential attributes to their profiles. The potential member profile attributes may be related to one or more member accomplishments.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a flowchart of a method of suggesting a member profile attribute to a member, according to some examples of the present disclosure.

FIG. 2 shows a flowchart of a method of using a machine learning algorithm to calculate a score that represents a likelihood that the information record describes an attribute of a particular member, according to some examples of the present disclosure.

FIG. 3 shows a flowchart of a method of building a model, according to some examples of the present disclosure.

FIG. 4 is a block diagram showing the functional components of a social networking service, according to some examples of the present disclosure.

FIG. 5 is a block diagram illustrating an example of a machine upon which one or more embodiments may be implemented.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. The present inventive subject matter is generally applicable to a wide range of information and networked services. For example, online job boards where users can view or post resumes and employers can post job openings.

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

Members may store information about themselves in their member profiles as attributes of the member profiles. Members may not always fully complete their member profiles, or may forget to update their member profiles when they have achieved a particular accomplishment. For example, a member may have an article published and may not add a profile attribute in their member profile to reflect this achievement. As another example, a member may receive a patent on an invention and may not add a profile attribute in their member profile to reflect this achievement. Both members and the social networking service benefit from members having complete member profiles. Members often search for and connect with other members that have certain profile attributes. Complete member profiles enable a more accurate search. In addition to members, recruiters and other third parties may make use of the member search functionality in looking for job candidates. In addition, many members utilize their member profiles as resumes, and having an up-to-date resume ensures that accomplishments do not get forgotten when the member needs to use the resume. Despite these benefits, members may not have time or remember to update their member profiles.

Disclosed in some examples are methods, systems, and machine readable mediums that utilize information ingested from publicly available network-based data sources to automatically suggest adding additional attributes to member profiles of a social networking service. Among other uses, this system allows for assisted member profile completion. The system ingests information from one or more publicly available network-based data sources (data sources that are different from the social networking service), creates information records that describe potential member profile attributes using that ingested data, identifies members of the social networking service that are associated with the information records using information in the information records and pre-existing member profile attributes, and then prompts one or more members to add the potential attributes to their profiles. The potential member profile attributes may be related to one or more member accomplishments.

As an example, the system may ingest publication information (e.g., citations to publications, content of publications, and the like) from a web site that posts publications, citations to publications, or both. The system may then create a record from that information which describes the publication. The publication may have one or more authors. The social networking service may identify one or more members of the social networking service that are the authors of the publication and prompt those members to add information about the publication to their member profiles. These members may then quickly and easily add the attribute by clicking on an “accept” or “yes” button. If the member accepts, the publication is added to a publications section of their member profile.

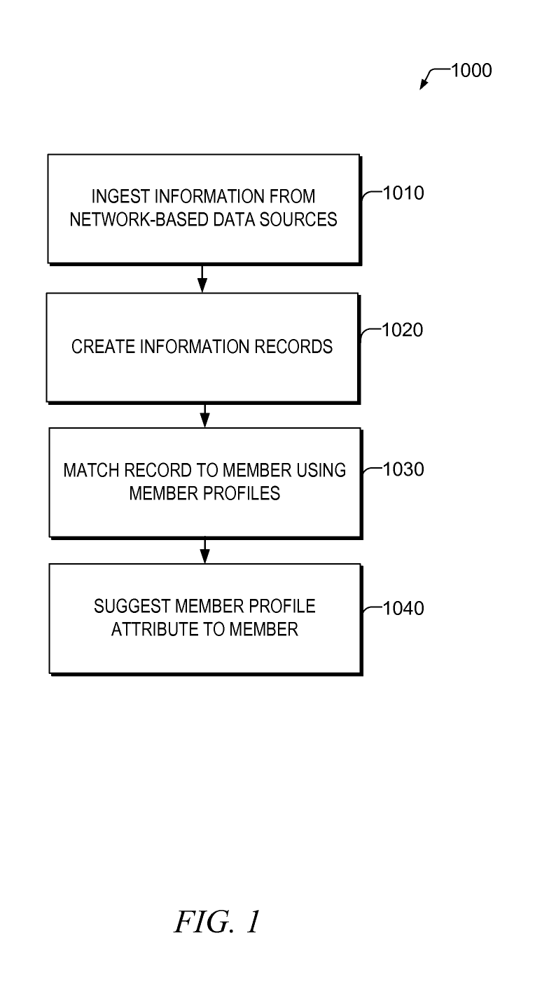

Turning now to FIG. 1, a method 1000 of suggesting a member profile attribute to a member is shown according to some examples of the present disclosure. At operation 1010 the social networking service may ingest information from network-based data sources. Example network-based data sources include publication databases, patent databases, citation databases, university databases, library databases, or any other network-based source of data that may relate to a potential attribute of a member such as a member's professional achievement. The data sources may be preselected by an administrator. Information may be ingested by extraction engines which may be custom modules which are designed for each data source based upon the specific content and format of the network-based data source. The extraction engines may scrape a web page of the data source, such as by extracting information from Hyper Text Markup Language (HTML), an eXtensible Markup Language (XML), JavaScript, or other web components. For example, the extraction engines parse the HTML or XML describing a public user interface of the network-based data source looking for particular, predefined text and then extract that text. Text may be found based upon contextual cues (e.g., the page may say “Author: Ted Jones”) whereby the extraction engine searches for the particular contextual cues (e.g., the string “Author”) and then extracts the text that follows until another contextual cue (e.g., a period or other punctuation marking the end of the author list). Contextual cues may also be structural cues, such as particular markup tags or location based cues (e.g., the desired text may be at a particular location in the document).

At operation 1020, the extraction engines create one or more information records from the extracted data. The information record is a data structure describing information about possible member profile attributes provided by the extracted information from the network-based data source. The information record stores the extracted information in a structured manner. For example, multiple publications may be described by information retrieved from the external data source. Each publication will correspond to an information record. For publications, the information record may contain one or more of: the name of the authors, the year published, the publication it was published in, information about the authors (other publications, contact information such as email address, institutional affiliations, and the like), the title, a subject, an abstract, and the like. For patents, the information record may contain one or more of: inventors, the assignee, the year granted, the year filed, the title, the abstract, and the like.

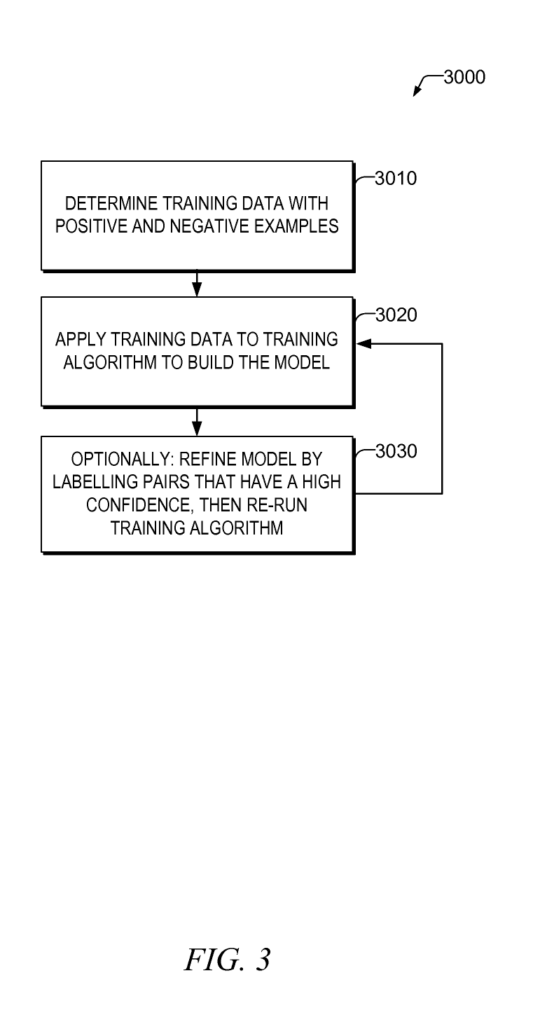

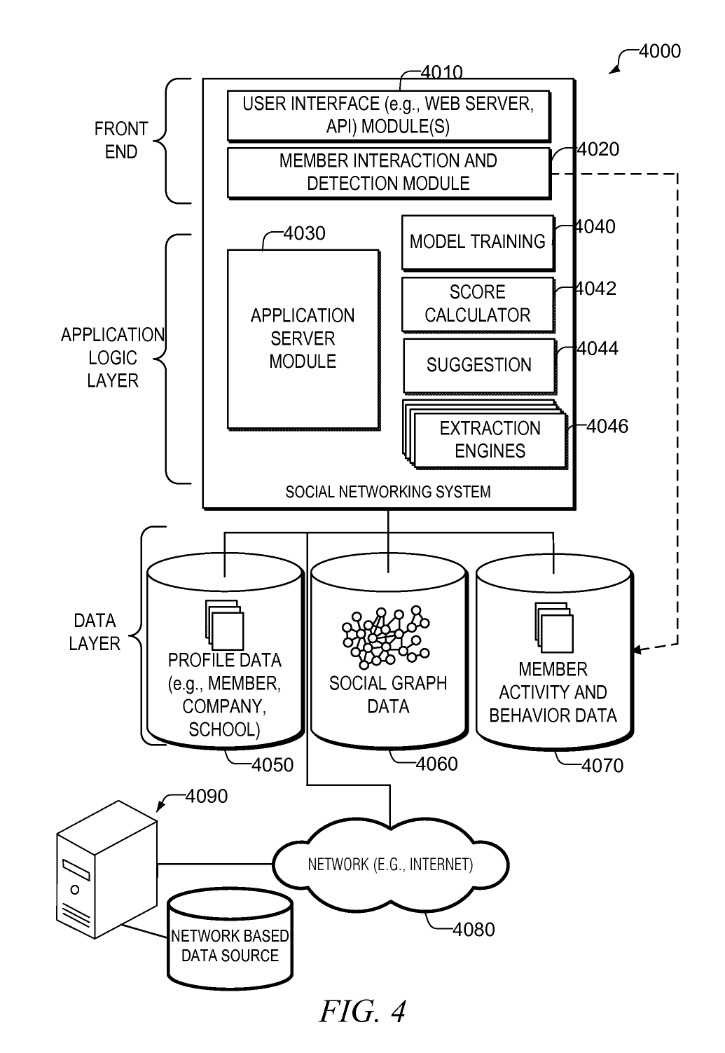

At operation 1030, the information records are matched to one or more member profiles of the social networking service. A machine learning algorithm is used to build an information model that is then used to compute a probability score that each member of the social networking service is associated with the information record. The machine learning algorithm takes as an input the information record, member profile, and in some examples: profiles of this member's connections, and any other data from the social network identified by the machine learning algorithm as relevant to the given predictive task. The machine learning algorithm then produces a probability score. The training and operation of the machine-learning algorithm will be described in more detail in FIGS. 3 and 4 and the accompanying description of those figures. The member(s) with the highest probability scores are then presented with a prompt or recommendation to add a profile attribute describing the information record at operation 1040. The user may then accept, decline, or ignore the suggestion. If the user accepts the suggestion the member profile attribute is added to the member profile. In some examples, the score may have to be greater than a predetermined threshold confidence level before a member is given a recommendation to add the attribute.

In some examples, computing a probability score for each [information record, member profile] pair may not be scalable as the social networking service may have millions of information records and millions of member profiles. In some examples the social networking service may first gather a list of candidate member profiles and then compute the probabilities for each [information record, member profile] pair only those candidates. Candidate selection may be performed on the basis of exact or approximate matching on a set of attributes. In some examples, such matching can be done based on member names from the member profiles and names of people in the information record. Instead of, or in addition to, using member names in the member profiles, other member profile attributes such as employer (e.g., company) names, names of educational institutions, educational degrees earned, and the like may be matched against any information in the information record, for the purposes of generating candidate matches.

In some examples, approximate matching on textual attributes such as member names is performed using approximate nearest neighbor methods such as Locally Sensitive Hashing (LSH). Given a textual string (e.g., a name), LSH will generate a grouping key such that any other textual string that has high enough similarity to the original string will be assigned the same grouping key. The degree of similarity between two text strings needed for their LSH keys to match is a configurable parameter, which can be used to control the number of candidate member and information record pairs generated.

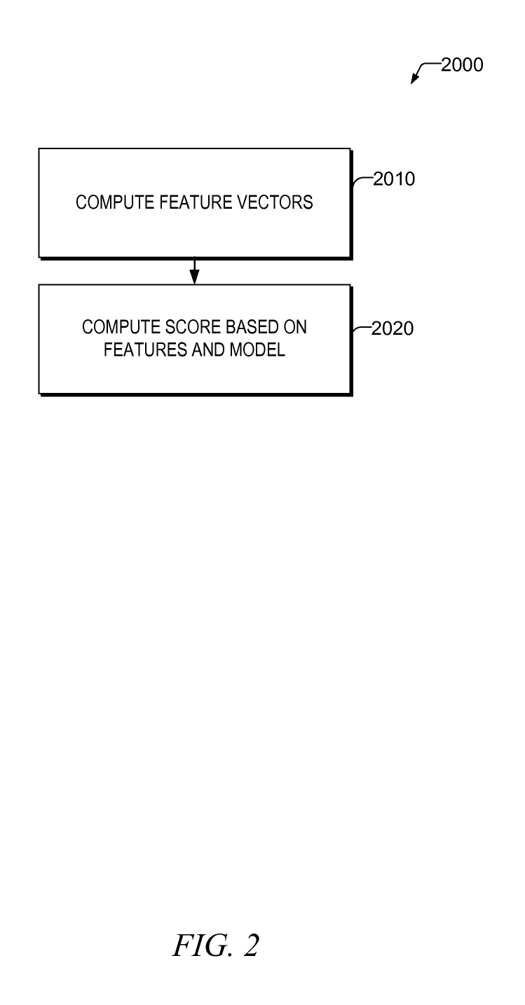

FIG. 2 shows an example method 2000 of using a machine learning algorithm to calculate a score that represents a likelihood that the information record describes an attribute of a particular member. At operation 2010 a feature vector is calculated. The feature vector is a data structure that represents various features of similarity between member profile attributes of the particular member and the information record. Features may include a similarity between the name of the member and an author of the publication or inventor of the patent, a similarity score between connections of the member and co-authors or co-inventors, a similarity score between a geography associated with the publication or patent and a geography of the member as expressed in a member's profile, a similarity score between keywords in the publication or patent (keywords may be determined using a Term Frequency, Inverse Document Frequency (TF-IDF) metric) and skills in the member's profile, a similarity score between the title of the publication or patent and titles of other publications shown in the member's profile, similarity scores between companies and educational institutions on the member's profile and author affiliations on the publication, similarity scores between companies and educational institutions on profiles of the member's connections and author affiliations on the publication. Other features may include member educational degrees (e.g., MD, PhD), fields of study, current and past industries of employment, names of past and present employers, skills, a match between an email address or other contact information in the information record, whether or not co-inventors or co-authors are connections on the social networking service, and the like. Similar features can be derived from profiles of member's connections (educational levels, fields of study, past and current employers, etc.).

Similarity scores may be calculated in a number of different ways, including calculating tf-idf scores for each term of each field being compared (both the information record and the member profile attribute) and then doing a cosine similarity based upon the vector of tf-idf terms for each field. Other similarity scores may include an edit distance that counts the minimum number of operations to transform one string into another; cosine, Euclidean, and other vector distances between character n-gram histograms; binary indicators of commonality between the information record and member attributes (e.g., overlap in names of employers the member worked at and authors' affiliations on the information record); as well as Jaccard and other set similarity coefficients (e.g., for computing a similarity score between a set of skills on the member's profile and those associated with the information record). For locations, a geographical distance metric may quantify a distance between two locations based upon the number of miles they are apart.

Once the similarity scores are calculated, in some examples, they are put into a vector (the feature vector). At operation 2020, the feature vector is multiplied by the dot product of a vector of weights that represent the learned information model to calculate the score for the [information record, member profile] pair. The score represents a probability that the information record corresponds to the member. The weights in the vector of weights quantify a learned importance of each particular feature at determining a score. Learning of the information model will be described with reference to FIG. 3. In some examples, the score is passed through a sigmoid calculation to produce a value that is between [0 . . . 1]. In some example machine learning algorithms, the feature vector is not multiplied by a vector of weights; rather, the features are input values into a decision model. Example decision model algorithms include tree models such as decision trees and random forest classifiers.

FIG. 3 shows one example method 3000 of building a model, according to some examples of the present disclosure. At operation 3010, the system determines training data with positive (the member matches the information record) and negative (the member does not match the information record) examples. In some examples, the training data may be selected from a set of data taken from one or more network-based data sources. Positive examples may be manually determined (e.g., a human may select [member, information record] pairs), or may be created from cases where there are exact matches between a field in the information record and the member profile that is highly associative of a positive match. For example, if the information record is for a publication, the information record has an email address that is the contact of an author, and an email in the member profile matches that email address, the social networking service may have a high confidence value that the member was an author of the paper. In some examples, negative examples may also be formed this same way, except that the social networking service may break the match; —that is, it may pair a [information record, member profile] together that do not have email matches.

At operation 3020, this training data is applied as input to a machine learning algorithm which produces an information model. For example, a vector of weights that describe the importance of a particular feature to the overall conclusion that the member is likely to be associated with the information record. In other examples, a decision tree (or multiple decision trees in the case of a random forest classifier) may be built. Example algorithms may include logistic regression, linear regression, support vector machines, and the like.

At operation 3030, optionally, the model may be refined by running the data through the model again, and then classifying the [information record, member] pairs that score high in the model as either matching (positive) or not matching (negative) examples. These classifications may then be fed back as additional positive or negative examples to further refine the model. The classifications may be done manually. In yet other examples, the classifications may be made by using instances in which a member chooses to add the attribute associated with the information record as positive examples and instances where the member chooses not to add the attribute as negative examples.

FIG. 4 is a block diagram showing the functional components of a social networking service 4000. As shown in FIG. 4, a front end may comprise a user interface module (e.g., a web server) 4010, which receives requests from various client-computing devices, and communicates appropriate responses to the requesting client devices. For example, the user interface module(s) 4010 may receive requests in the form of Hypertext Transport Protocol (HTTP) requests, or other network-based, application programming interface (API) requests (e.g., from a dedicated social networking service application running on a client device). In addition, a member interaction and detection module 4020 may be provided to detect various interactions that members have with different applications, services and content presented. As shown in FIG. 4, upon detecting a particular interaction, the member interaction and detection module 4020 logs the interaction, including the type of interaction and any meta-data relating to the interaction, in the member activity and behavior database 4070.

An application logic layer may include one or more various application server modules 4030, which, in conjunction with the user interface module(s) 4010, generate various graphical user interfaces (e.g., web pages) with data retrieved from various data sources in the data layer. With some embodiments, application server module 4030 is used to implement the functionality associated with various applications and/or services provided by the social networking service as discussed above.

Application layer may include model training module 4040, score calculator module 4042, suggestion module 4044 and extraction engines 4046. Extraction engines 4046 may be specifically programmed modules that are specifically designed to access a particular network-based data source, for example, network based data source 4090 accessible over network 4080. For example, one extraction engine 4046 may access a particular publication server, while another extraction engine 4046 may access a different publication server. The extraction engines 4046 may communicate with the network-based data sources over a computer network (e.g., network 4080) using standard network communication protocols and may programmatically (e.g., through an Application Programming Interface—API) access the network-based data source. In other examples, extraction engines 4046 may access a public user interface (e.g., an HTML page). Extraction engines 4046 may create one or more information records corresponding to each potential member profile attribute (e.g., for each publication, patent, and the like). The information records may contain one or more attributes of the possible member profile attributes that are collected from the network-based information source. Possible member profile attributes may correspond to member achievements.

Model training module 4040 may apply a machine learning algorithm to one or more training data sets to build an information model, as detailed above. In some examples, the information model is then used by the score calculator module 4042 to calculate a score that represents a likelihood that the information record describes an attribute of a member (for example, a publication or patent authored by or invented by the member).

The application layer may also include suggestion module 4044, which may suggest that the member with the highest score add the item to their member profile as an attribute. In some examples, the suggestion module 4044 may present, via the user interface module 4010, a graphical user interface which may contain the suggestion that the member add the attribute to their profiles.

The social networking service 4000 may include a data layer that may include several other databases, such as a database 4050 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 4050. Similarly, when a representative of an organization initially registers the organization with the social networking service, the representative may be prompted to provide certain information about the organization. This information may be stored, for example, in the database 4050, or another database (not shown). With some embodiments, the profile data may be processed (e.g., in the background or offline) to generate various derived profile data. For example, if a member has provided information about various job titles that the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 4060. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 4 by the member activity and behavior database 4070.

With some embodiments, the social networking system 4000 provides an application programming interface (API) module with the user interface module 4010 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

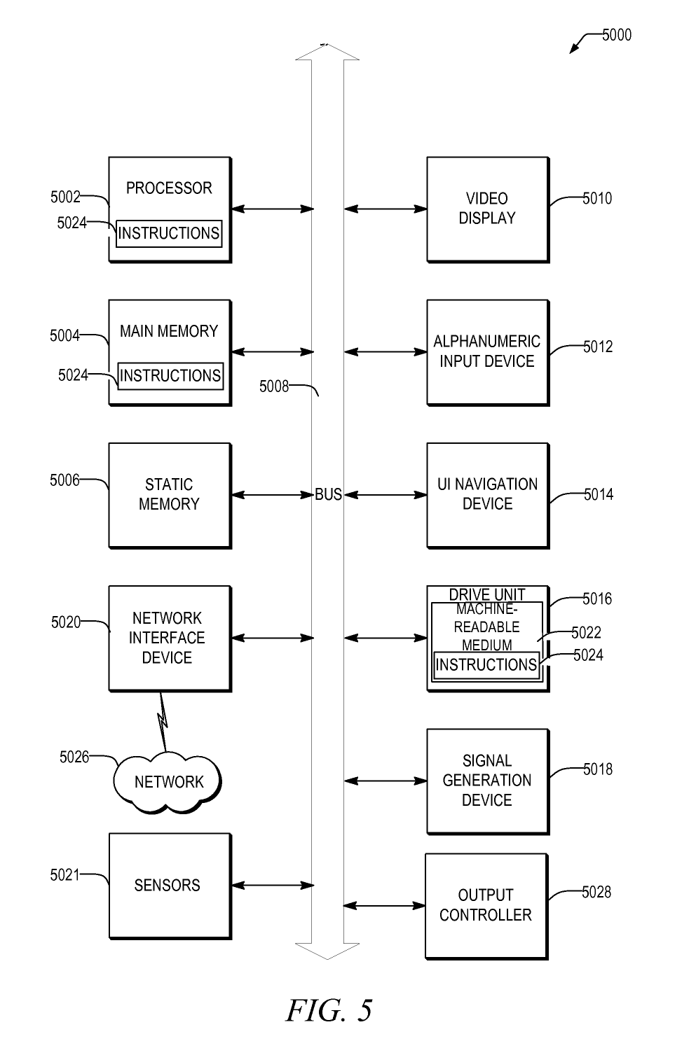

FIG. 5 illustrates a block diagram of an example machine 5000 upon which any one or more of the techniques (e.g., methodologies) discussed herein may perform. In alternative embodiments, the machine 5000 may operate as a standalone device or may be connected (e.g., networked) to other machines. In a networked deployment, the machine 5000 may operate in the capacity of a server machine, a client machine, or both in server-client network environments. In an example, the machine 5000 may act as a peer machine in peer-to-peer (P2P) (or other distributed) network environment. The machine 5000 may implement or include any portion of the social networking service from FIG. 4, and may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 5000 may include a hardware processor 5002 (e.g., a central processing unit (CPU), a graphics processing unit (GPU), a hardware processor core, or any combination thereof), a main memory 5004 and a static memory 5006, some or all of which may communicate with each other via an interlink (e.g., bus) 5008. The machine 5000 may further include a display unit 5010, an alphanumeric input device 5012 (e.g., a keyboard), and a user interface (UI) navigation device 5014 (e.g., a mouse). In an example, the display unit 5010, input device 5012 and UI navigation device 5014 may be a touch screen display. The machine 5000 may additionally include a storage device (e.g., drive unit) 5016, a signal generation device 5018 (e.g., a speaker), a network interface device 5020, and one or more sensors 5021, such as a global positioning system (GPS) sensor, compass, accelerometer, or other sensor. The machine 5000 may include an output controller 5028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 5016 may include a machine readable medium 5022 on which is stored one or more sets of data structures or instructions 5024 (e.g., software) embodying or utilized by any one or more of the techniques or functions described herein. The instructions 5024 may also reside, completely or at least partially, within the main memory 5004, within static memory 5006, or within the hardware processor 5002 during execution thereof by the machine 5000. In an example, one or any combination of the hardware processor 5002, the main memory 5004, the static memory 5006, or the storage device 5016 may constitute machine readable media.

While the machine readable medium 5022 is illustrated as a single medium, the term “machine readable medium” may include a single medium or multiple media (e.g., a centralized or distributed database, and/or associated caches and servers) configured to store the one or more instructions 5024.

The term “machine readable medium” may include any medium that is capable of storing, encoding, or carrying instructions for execution by the machine 5000 and that cause the machine 5000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 5024 may further be transmitted or received over a communications network 5026 using a transmission medium via the network interface device 5020. The Machine 5000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 5020 may include one or more physical jacks (e.g., Ethernet, coaxial, or phone jacks) or one or more antennas to connect to the communications network 5026. In an example, the network interface device 5020 may include a plurality of antennas to wirelessly communicate using at least one of single-input multiple-output (SIMO), multiple-input multiple-output (MIMO), or multiple-input single-output (MISO) techniques. In some examples, the network interface device 5020 may wirelessly communicate using Multiple User MIMO techniques.

What is claimed is:

1. A method comprising:
ingesting data from a network based data source by at least one of: scraping a publicly accessible web-page or utilizing an Application Programming Interface (API) of the network based data source;
creating an information record describing a possible member profile attribute containing at least some of the ingested data, the information record structuring the at least some of the ingested data;
matching the information record to a member profile corresponding to a member of a social networking service using a machine learned information model based upon one or more features computed using at least the member profile and the information record; and
creating a graphical user interface descriptor, the graphical user interface descriptor including a user interface input element that allows the member to add the possible member profile attribute as an attribute in the member profile.

2. The method of claim 1, wherein matching the information record to the member profile comprises:
scoring each particular one of a plurality of member profiles of the social networking service utilizing the machine learned information model based upon one or more features computed using the particular one of the plurality of member profiles and the information record; and
selecting as the member profile the one of the plurality of member profiles of the social networking service that has the highest score.

3. The method of claim 2, wherein the information model comprises a plurality of feature weights and wherein scoring each particular one of the plurality of member profiles comprises:
calculating a feature vector from the information record and attributes of the particular one of the plurality of member profiles; and
wherein the score is a dot product of the feature vector and the feature weights.

4. The method of claim 3, wherein calculating the feature vector comprises calculating a similarity between a first member profile attribute of the particular one of the plurality of member profiles and an attribute in the information record.

5. The method of claim 4, wherein the first member profile attribute is a name and the attribute in the information record is an author name.

6. The method of claim 2, comprising:
creating the machine learned information model by submitting a set of training examples to a machine learning algorithm.

7. The method of claim 6, wherein the training examples comprise positive and negative examples and wherein the positive examples are determined based upon an email match between an email in a member's profile and an email address in the information record.

8. The method of claim 1, wherein the possible member profile attribute is one of: a patent, a publication, and an award.

9. The method of claim 1, wherein at least one of the one or more features are also computed using profiles of connections of the member.

10. A non-transitory machine-readable medium that stores instructions which when performed by a machine, cause the machine to perform operations comprising:
ingesting data from a network based data source by at least one of: scraping a publicly accessible web-page or utilizing an Application Programming Interface (API) of the network based data source;
creating an information record describing a possible member profile attribute containing at least some of the ingested data, the information record structuring the at least some of the ingested data;
matching the information record to a member profile corresponding to a member of a social networking service using a machine learned information model based upon one or more features computed using at least the member profile and the information record; and
creating a graphical user interface descriptor, the graphical user interface descriptor including a user interface input element that allows the member to add the possible member profile attribute as an attribute in the member profile.

11. The machine-readable medium of claim 10, wherein the operations of matching the information record to the member profile comprises the operations of:
scoring each particular one of a plurality of member profiles of the social networking service utilizing the machine learned information model based upon one or more features computed using the particular one of the plurality of member profiles and the information record; and
selecting as the member profile the one of the plurality of member profiles of the social networking service that has the highest score.

12. The machine-readable medium of claim 11, wherein the information model comprises a plurality of feature weights and wherein the operations of scoring each particular one of the plurality of member profiles comprises the operations of:
calculating a feature vector from the information record and attributes of the particular one of the plurality of member profiles; and
wherein the score is a dot product of the feature vector and the feature weights.

13. The machine-readable medium of claim 12, wherein the operations of calculating the feature vector comprises the operations of calculating a similarity between a first member profile attribute of the particular one of the plurality of member profiles and an attribute in the information record.

14. The machine-readable medium of claim 13, wherein the first member profile attribute is a name and the attribute in the information record is an author name.

15. The machine-readable medium of claim 11, wherein the operations comprise:
creating the machine learned information model by submitting a set of training examples to a machine learning algorithm.

16. The machine-readable medium of claim 15, wherein the training examples comprise positive and negative examples and wherein the operations comprise determining the positive examples based upon an email match between an email in a member's profile and an email address in the information record.

17. The machine-readable medium of claim 10, wherein the possible member profile attribute is one of: a patent, a publication, and an award.

18. The machine-readable medium of claim 10, wherein at least one of the one or more features are also computed using profiles of connections of the member.

19. A system comprising:
one or more processors;
a machine readable medium coupled to the one or more processors and configured to cause the processor to perform operations comprising:
ingesting data from a network based data source by at least one of: scraping a publicly accessible web-page or utilizing an Application Programming Interface (API) of the network based data source;
creating an information record describing a possible member profile attribute containing at least some of the ingested data, the information record structuring the at least some of the ingested data;
matching the information record to a member profile corresponding to a member of a social networking service using a machine learned information model based upon one or more features computed using at least the member profile and the information record; and
creating a graphical user interface descriptor, the graphical user interface descriptor including a user interface input element that allows the member to add the possible member profile attribute as an attribute in the member profile.

20. The system of claim 19, wherein the operations of matching the information record to the member profile comprises operations of:
scoring each particular one of a plurality of member profiles of the social networking service utilizing the machine learned information model based upon one or more features computed using the particular one of the plurality of member profiles and the information record; and
selecting as the member profile the one of the plurality of member profiles of the social networking service that has the highest score.

21. The system of claim 20, wherein the information model comprises a plurality of feature weights and wherein the operations of scoring each particular one of the plurality of member profiles comprises operations of:
calculating a feature vector from the information record and attributes of the particular one of the plurality of member profiles; and
wherein the score is a dot product of the feature vector and the feature weights.
